(19) United States
(12) Patent Application Publication
(10) Pub. No.: US 2026/0132330 A1
(43) Pub. Date: May 14, 2026

(54) HIGH-TEMPERATURE FOAM FRACTURING FLUID WITH SYNTHETIC POLYMER

(71) Applicant: Schlumberger Technology Corporation, Sugar Land, TX (US)

(72) Inventors: Anna Beletskaya, Sugar Land, TX (US); Christopher S. Daeffler, Sugar Land, TX (US); Ahmed Rabie, Sugar Land, TX (US); Javier Sanchez Reyes, Sugar Land, TX (US); Melissa Chia Mei Teoh, Paris (FR); Alvinda Sri Hanamertani, Sugar Land, TX (US); Oscar Rincon Ortiz, Sugar Land, TX (US); Roberto Tineo, Dhahran (SA)

(21) Appl. No.: 19/368,169

(22) Filed: Oct. 24, 2025

Related U.S. Application Data
(60) Provisional application No. 63/719,941, filed on Nov. 13, 2024.

(51) Int. Cl. C09K 8/70; C09K 8/60; C09K 8/68; E21B 43/26

(52) U.S. Cl. CPC C09K 8/703; C09K 8/602; C09K 8/685; E21B 43/26; C09K 2208/12

(57) ABSTRACT

The present disclosure provides a two-phase liquid-gas fluid for hydraulic fracturing, including a liquid phase including a foaming surfactant and a branched synthetic polymer, wherein the polymer includes monomers selected from the group consisting of acrylamide, acrylic acid, methacrylic acid, 2-acrylamido-2-methylpropane sulfonic acid, and combinations thereof, and a gas phase comprising CO₂, wherein the fluid maintains a viscosity of at least 70 cp after exposure to temperatures of 200° F. to 300° F. for at least 90 minutes. The foam fluid demonstrates thermal stability at high temperatures and maintains stable viscosity under high temperature and pressure conditions, making the fluid suitable for hydraulic fracturing applications in high-temperature reservoirs.

### BACKGROUND

Hydraulic fracturing is a widely used technique for enhancing hydrocarbon extraction from subsurface geological formations by injecting fluid at pressures higher than formation pressure to create fractures in the rock. Fracturing fluids perform two functions: transmitting pressure from the surface to the fracture tip with minimal pressure drop, and transporting proppant particles throughout the fracture with uniform distribution and minimal settling. These requirements present conflicting viscosity demands, as pressure transmission benefits from low viscosity while proppant transport requires higher viscosity. Foam fracturing fluids, which contain both liquid and gas phases with higher gas-to-liquid volume ratios than energized fluids, offer advantages including low leak-off, improved proppant transport, compatibility with water-sensitive formations, and reduced fracture conductivity damage. However, maintaining foam stability at elevated temperatures remains a challenge in the development of effective foam fracturing systems for high-temperature reservoir applications.

### SUMMARY

According to an aspect of the present disclosure, a two-phase liquid-gas fluid for hydraulic fracturing is provided. The fluid includes a liquid phase including a foaming surfactant and a branched synthetic polymer, wherein the polymer includes monomers including at least one of acrylamide, acrylic acid, methacrylic acid, 2-acrylamido-2-methylpropane sulfonic acid, and combinations thereof. The fluid further includes a gas phase including CO₂, wherein the fluid maintains a viscosity of at least 70 cp after exposure to temperatures of 200° F. to 300° F. for at least 90 minutes.

According to other aspects of the present disclosure, the fluid may include one or more of the following features. The polymer may be internally crosslinked with functional groups containing ammonium. A concentration of the polymer may be from about 10 ppt to about 200 ppt. The concentration of the polymer may be between about 40 ppt and about 45 ppt. A concentration of the foaming surfactant may be up to about 60 gpt. The foaming surfactant may include a betaine or sultaine group. The foaming surfactant may include at least one of: an alkylamido betaine; an alkylamido sultaine, an alkyl polyglycolide; an amine oxide; a quaternary amine; an alkyl ether sulfate; an alkylarylsulfonate; an ethoxylated long chain alcohol; an alkyl sulfate; a sulfosuccinate; a sodium lauryl sulfoacetate; or a sodium lauroyl methyl isethionate. The liquid phase may further include a clay stabilizer. The clay stabilizer may include choline chloride, tetramethylammonium chloride, triethylenetetramine, a polyether amine, a cationic polymer, or a combination thereof. A foam quality of the fluid may be from about 10% to about 75%. The foam quality may be from about 54% to about 74%.

According to another aspect of the present disclosure, a method for hydraulic fracturing of a subsurface formation is provided. The method includes preparing a foam fluid including a liquid phase and a gas phase, wherein the liquid phase includes a foaming surfactant and a branched synthetic polymer including monomers having at least one of acrylamide, acrylic acid, methacrylic acid, 2-acrylamido-2-methylpropane sulfonic acid, and combinations thereof, and wherein the gas phase includes CO₂. The method further includes injecting the foam fluid into the subsurface formation at a pressure higher than formation pressure to create fractures in the formation.

According to other aspects of the present disclosure, the method may include one or more of the following features. The polymer may be internally crosslinked with functional groups containing ammonium. The liquid phase may further include a clay stabilizer selected from the group including at least one of choline chloride, tetramethylammonium chloride, triethylenetetramine, a polyether amine, a cationic polymer, and combinations thereof. The clay stabilizer may include choline chloride. The foam fluid may have a foam quality of from about 54% to about 74%.

According to another aspect of the present disclosure, a composition for high-temperature hydraulic fracturing is provided. The composition includes a branched synthetic polymer including monomers selected from the group including at least one of acrylamide, acrylic acid, methacrylic acid, 2-acrylamido-2-methylpropane sulfonic acid, and combinations thereof, wherein the polymer is internally crosslinked with functional groups containing ammonium. The composition further includes a foaming surfactant including a betaine or sultaine group, wherein the composition is formulated to maintain thermal stability at temperatures up to 300° F.

According to other aspects of the present disclosure, the composition may include one or more of the following features. The foaming surfactant may include one or more alkylamido betaines selected from the group including at least one of cocamidopropyl hydroxysultaine, cocamidopropyl betaine, erucic amidopropyl dimethyl betaine, oleoylamidopropyl dimethyl betaine, erucamidopropyl hydroxypropylsultaine, and erucamidopropyl hydroxypropylsultaine. The composition may further include a clay stabilizer selected from the group including at least one of choline chloride, tetramethylammonium chloride, triethylenetetramine, a polyether amine, and a cationic polymer. The clay stabilizer may include choline chloride and may be present at a concentration that does not significantly reduce the viscosity of the polymer solution.

### BRIEF DESCRIPTION OF FIGURES

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 shows a perforation system for forming perforations in a wellbore, according to an embodiment;

FIG. 2 shows a viscosity profile of an aqueous solution containing a branched polymer and clay stabilizer, according to an embodiment;

FIG. 3A shows a viscosity profile of a two-phase fluid over time, according to an embodiment;

FIG. 3B shows a viscosity profile of the two-phase fluid of FIG. 3A under elevated conditions, according to an embodiment;

FIG. 4 shows a graph of viscosity of a base fluid over time, according to an embodiment;

FIG. 5 shows a graph of the viscosity of the foam fluid containing base fluid of FIG. 4 and CO2 in the gas phase obtained with circulating pipe rheometer, according to an embodiment;

FIG. 6 shows viscosity measurements of a synthetic polymer solution in different water types, according to an embodiment; and

FIG. 7 shows viscosity and temperature measurements of synthetic polymer and biopolymer combinations, according to an embodiment.

### DETAILED DESCRIPTION

Hydraulic fracturing represents a widely utilized technique for enhancing hydrocarbon production from subsurface geological formations. The process involves injecting a fluid at pressures exceeding formation pressure to create fractures in the rock formation, thereby improving the flow of hydrocarbons to the surface. Various fracturing fluids have been developed to meet specific geological demands, with water typically serving as the primary component along with additives that adjust the fluid's properties for effective proppant transport and fracture creation.

Gas-containing fluids, commonly referred to as foams, offer advantages in certain reservoir conditions, particularly in low-pressure or depleted reservoirs where the reduced density facilitates flowback of the fracturing fluid. These two-phase liquid-gas fluids include a liquid component, typically referred to as the base fluid, and a gas phase with the volume percentage of gas under downhole conditions known as the foam quality. The liquid phase may include polymers, surfactants, and other additives that contribute to foam stability and performance characteristics.

Foam stability presents challenges due to the thermodynamically unstable nature of foam systems, which arises from high interfacial energy and surface tension at the boundary between liquid and gas phases. This instability leads to foam collapse through drainage, coalescence, and coarsening processes. Drainage occurs when liquid moves within the foam due to gravity and capillary forces, leading to thinning of liquid films between bubbles. Coalescence involves the breaking of liquid films that separate neighboring bubbles, resulting in the merging of smaller bubbles into larger ones. Coarsening involves gas transfer through liquid films from smaller to larger bubbles, increasing bubble sizes and reducing bubble count.

Temperature represents a factor affecting foam stability, as elevated temperatures may cause degradation of surfactants and polymers, desorption of surfactants from bubble surfaces, and increased drainage as liquid phase viscosity decreases. High-temperature applications therefore require foam formulations that maintain structural integrity and performance characteristics under thermal stress. The development of foam fluids that remain stable at elevated temperatures addresses the demands of deep formations and high-temperature reservoir conditions.

The disclosed foam fracturing fluid includes a liquid phase containing a foaming surfactant and a branched synthetic polymer, along with a gas phase. The branched synthetic polymer may include monomers such as acrylamide, acrylic acid, methacrylic acid, and 2-acrylamido-2-methylpropane sulfonic acid, which contribute to thermal stability and viscosity maintenance. In at least one embodiment, the branched synthetic polymer may be limited to a group consisting of the monomers listed. In at least one embodiment, the branched synthetic polymer may include more than those listed. The foaming surfactant may include betaine-containing compounds that enhance foam formation and stability. This combination provides a fluid system that maintains performance characteristics at temperatures up to 300° F. while offering compatibility with various oilfield fluids and applications.

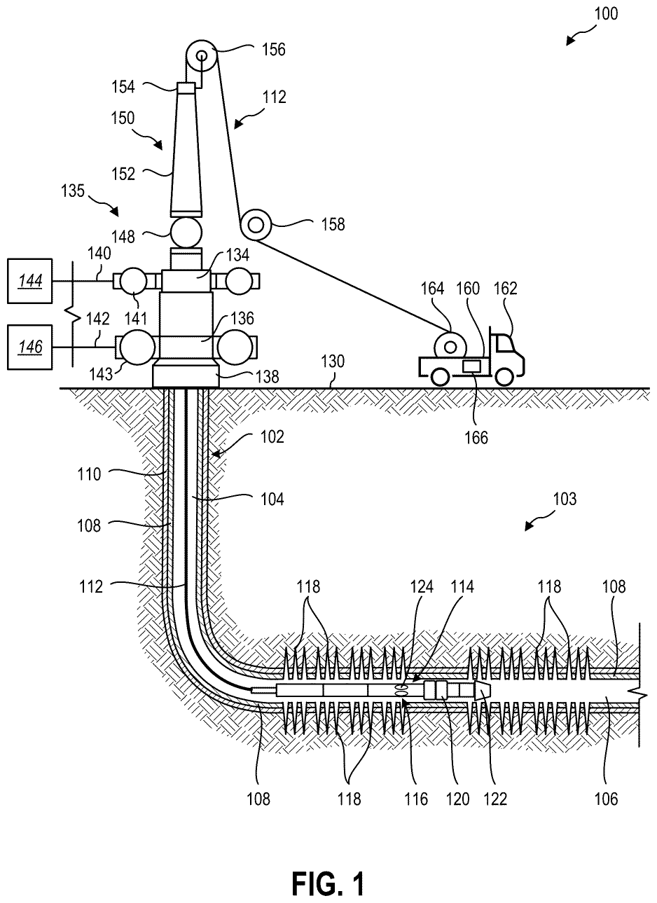

Referring to FIG. 1, a perforation system 100 may be configured for forming perforations in a wellbore 102 and an earth formation 103 through which the wellbore 102 extends. The perforation system 100 provides a means for creating openings that facilitate fluid communication between the wellbore 102 and surrounding geological structures. The earth formation 103 may include various rock types and geological layers that contain hydrocarbons or other subsurface fluids. The wellbore 102 may be formed through drilling operations that penetrate the earth formation 103 to access hydrocarbon-bearing zones at various depths and orientations.

The wellbore 102 may include a vertical portion 104 and a horizontal portion 106 that extends laterally through the earth formation 103. The vertical portion 104 may extend downward from the surface through multiple geological layers, while the horizontal portion 106 may be oriented substantially parallel to bedding planes or other geological features within the earth formation 103. This configuration allows for enhanced contact with hydrocarbon-bearing zones and may improve production efficiency. The transition between the vertical portion 104 and the horizontal portion 106 may occur at various depths depending on the target formation characteristics and drilling objectives.

The wellbore 102 may be lined with casing 108 that provides structural integrity and isolation between different zones within the earth formation 103. The casing 108 may include steel tubulars or other materials that resist corrosion and maintain wellbore stability under downhole conditions. The casing 108 may extend through both the vertical portion 104 and the horizontal portion 106, providing a continuous barrier between the wellbore fluids and the surrounding earth formation 103. Multiple casing strings of different diameters may be installed at various depths to accommodate different operational requirements and formation characteristics.

Cement 110 may be positioned in an annular space between the casing 108 and the earth formation 103 to provide zonal isolation and structural support. The cement 110 may include Portland cement or other cementing materials that cure to form a solid barrier. The cement 110 may prevent fluid migration between different zones within the earth formation 103 and may provide additional structural support for the casing 108. The cement 110 may extend along portions of both the vertical portion 104 and the horizontal portion 106, depending on the completion design and regulatory requirements. The perforation system 100 may be configured to penetrate through both the casing 108 and the cement 110 to establish fluid communication with the earth formation 103.

A wireline 112 may extend into the wellbore 102 to convey downhole equipment and facilitate various wellbore operations. The wireline 112 may include one or more electrical cables configured to transmit data and signals to downhole components, enabling real-time communication and control during operations. The wireline 112 may include a protective sheath or jacket disposed around internal portions to provide protection against wellbore fluids and mechanical wear. In some embodiments, the wireline 112 may include a steel wire armored cable that provides structural strength and electrical conductivity for downhole operations. The protective sheath may be formed of fluid-resistant materials such as epoxy compounds that resist degradation from exposure to various wellbore fluids and chemicals.

The wireline 112 may carry a bottomhole assembly 114 that includes various tools and components for performing downhole operations within the wellbore 102. The bottomhole assembly 114 may be configured to perform multiple functions during a single trip into the wellbore 102, thereby improving operational efficiency and reducing the time required for completion activities. The bottomhole assembly 114 may include components that are selectively activated or operated based on downhole conditions or surface commands transmitted through the wireline 112. In some embodiments, the bottomhole assembly 114 may be positioned at predetermined locations within the wellbore 102 using depth control systems that monitor the position of the assembly relative to target zones within the earth formation 103.

The bottomhole assembly 114 may include a perforating gun 116 configured to create openings through the casing 108 and cement 110 to establish fluid communication with the earth formation 103. The perforating gun 116 may contain shaped charges that are designed to penetrate through multiple barriers including the casing 108, the cement 110, and portions of the earth formation 103 surrounding the wellbore 102. The perforating gun 116 may be configured to fire the shaped charges at predetermined locations along the wellbore 102 to create perforations 118 that extend from the wellbore 102 into the earth formation 103. The perforations 118 may provide pathways for fluid communication between the wellbore 102 and hydrocarbon-bearing zones within the earth formation 103, enabling the flow of formation fluids into the wellbore 102 for production or the injection of treatment fluids into the formation.

The perforating gun 116 may include spaced perforations 124 through which the shaped charges are discharged into the casing 108 and surrounding materials. The spaced perforations 124 may be positioned at predetermined intervals along the length of the perforating gun 116 to provide controlled placement of the shaped charges. In some embodiments, the spaced perforations 124 may be oriented at specific angles relative to the axis of the perforating gun 116 to direct the shaped charges in desired directions within the earth formation 103. The spacing and orientation of the spaced perforations 124 may be selected based on formation characteristics, completion objectives, and the desired pattern of perforations 118 to be created in the wellbore 102. The shaped charges may be activated simultaneously or in sequence to create the perforations 118 through the casing 108, cement 110, and into the earth formation 103.

The bottomhole assembly 114 may further include a plug setting tool 120 configured to place a plug 122 within the wellbore 102 to provide zonal isolation during completion operations. The plug setting tool 120 may be designed to transport the plug 122 to a predetermined location within the wellbore 102 and deploy the plug 122 to create a seal against the inner surface of the casing 108. The plug 122 may include expandable elements that engage with the casing 108 to prevent fluid flow past the plug 122 location. In some embodiments, the plug 122 may include sealing elements such as elastomeric packers that conform to the inner surface of the casing 108 to provide effective sealing under downhole pressure and temperature conditions. The plug setting tool 120 may include mechanisms for expanding the plug 122 and securing the plug 122 in position within the wellbore 102.

As further shown in FIG. 1, the plug 122 may be positioned to isolate previously perforated sections of the wellbore 102 from subsequent completion operations. The plug 122 may be placed uphole of existing perforations 118 to prevent treatment fluids from entering previously completed zones during fracturing operations in new zones. The plug setting tool 120 may be activated through signals transmitted via the wireline 112 to deploy the plug 122 at the desired location. Once activated, the plug setting tool 120 may cause the plug 122 to expand radially and engage with the inner surface of the casing 108 to form a pressure-tight seal. The plug 122 may be designed to withstand differential pressures encountered during subsequent fracturing operations while maintaining isolation between different zones within the wellbore 102. The placement of the plug 122 enables staged completion operations where different sections of the wellbore 102 may be treated independently to optimize hydrocarbon recovery from the earth formation 103.

At a surface 130, the wellbore 102 may be equipped with various control systems and equipment that facilitate fluid injection and production operations. A fluid flow control system 135 may be positioned at the surface 130 to direct and control the flow of treatment fluids into the wellbore 102 and to manage the flow of formation fluids out of the wellbore 102 during production operations. The fluid flow control system 135 may include multiple components including flow control valves, spools, flow crosses, and fittings that work together to provide operational control over fluid movement. A first flow control device 134 and a second flow control device 136 may be incorporated within the fluid flow control system 135 to provide selective control over different fluid streams or operational modes. The first flow control device 134 and the second flow control device 136 may each include valve assemblies that can be opened or closed to permit or prevent fluid flow through designated pathways. In some embodiments, the fluid flow control system 135 may include blow-out preventer components that provide safety control by preventing uncontrolled flow of formation fluids from the wellbore 102 to the surface 130.

The fluid flow control system 135 may be coupled to a wellhead 138 that terminates the wellbore 102 at the surface 130 and provides a connection point for various surface equipment and fluid handling systems. A first fluid conduit 140 may be connected to the first flow control device 134 through a first valve 141 to enable selective fluid communication between external fluid sources and the wellbore 102. The first fluid conduit 140 may be configured to transport various fluids including pumpdown fluids, acid treatments, stimulation fluids, completion fluids, fracturing fluids, or corrosion inhibitor compositions to the wellbore 102 as operational requirements dictate. A second fluid conduit 142 may be connected to the second flow control device 136 through a second valve 143 to provide an additional pathway for fluid delivery or to enable simultaneous injection of different fluid types. A first pump 144 may be operatively connected to the first fluid conduit 140 to provide the pressure and flow rate needed to deliver fluids through the first flow control device 134 and into the wellbore 102. A second pump 146 may be operatively connected to the second fluid conduit 142 to provide independent pumping capability for fluids delivered through the second flow control device 136. The first pump 144 and the second pump 146 may be configured to operate at different pressures and flow rates to accommodate various operational requirements including fracturing operations that may utilize the disclosed foam fluid compositions.

An access valve 148 may be incorporated within the fluid flow control system 135 to facilitate vertical access to the wellbore 102 by the bottomhole assembly 114 or other downhole tools while maintaining pressure control during operations. A sealing and alignment assembly 150 may be operatively coupled to the access valve 148 to provide sealing around the wireline 112 during deployment, conveyance, intervention, and other wellsite operations performed while the wireline 112 extends within the wellbore 102. The sealing and alignment assembly 150 may include a lock chamber 152 mounted above the access valve 148 that functions as a lubricator, airlock, or riser to enable safe insertion and removal of downhole equipment under pressure conditions. A stuffing box 154 may be configured within the sealing and alignment assembly 150 to create a seal around the outer surface of the wireline 112 at an upper portion of the lock chamber 152, where the stuffing box 154 may utilize annular packings applied around the surface of the wireline 112 or may inject sealing fluids between the outer surface of the wireline 112 and an inner wall of the stuffing box 154. A pulley 156 may be positioned to guide the wireline 112 into the stuffing box 154, while a guide pulley 158 may direct the wireline 112 between the pulley 156 and a conveyance device 160 such as a winch system that controls the movement of the wireline 112 within the wellbore 102. The wireline 112 may be supplied from a drum 164 that may be carried by a vehicle 162 along with the conveyance device 160, where the drum 164 may be rotated by an actuator 166 that may include an electric motor, hydraulic motor, or other means for selectively unwinding and winding the wireline 112 around the drum 164 while applying adjustable tensile forces to control the position and movement of the bottomhole assembly 114 within the wellbore 102.

The liquid phase of the foam fracturing fluid, for example fluid used in the perforation system 100 shown in FIG. 1 and described above, may include a branched synthetic polymer and a foaming surfactant that work together to provide thermal stability and foam formation characteristics under high-temperature downhole conditions. The branched synthetic polymer may serve as a viscosity-building agent that maintains fluid properties at elevated temperatures while contributing to foam stability through polymer-surfactant interactions. The polymer may be formulated with specific monomer compositions that provide thermal resistance and compatibility with various oilfield fluids encountered during fracturing operations.

The branched synthetic polymers described herein may include monomers selected from acrylamide, acrylic acid, methacrylic acid, and 2-acrylamido-2-methylpropane sulfonic acid, which may be combined in various ratios to achieve desired performance characteristics. In at least one embodiment, the branched synthetic polymer may be limited to a group consisting of those monomers listed. In at least one embodiment, the branched synthetic polymer may include more than those listed. Acrylamide monomers may provide backbone structure and thermal stability, while acrylic acid and methacrylic acid monomers may contribute to polymer solubility and interaction with divalent cations present in formation waters. The 2-acrylamido-2-methylpropane sulfonic acid monomer may enhance thermal stability and provide ionic character that improves polymer performance in high-salinity environments. In some embodiments, the polymer may include additional monomers such as N-(3-(dimethylamino) propyl) acrylamide, 2-sulfoethyl methacrylate, pendant amine-bearing monomers, N-(3-(dimethylamino) propyl) methaacrylamide (DMAPMA), dimethylaminoethyl acrylate (DMAEA), dimethylaminoethyl methacrylate, or maleic anhydride to further modify polymer properties and performance characteristics. These additional monomers may provide enhanced thermal stability, improved salt tolerance, or modified rheological behavior depending on the specific application requirements and formation conditions.

The polymer may be internally crosslinked with functional groups containing ammonium to provide enhanced thermal stability and viscosity retention at elevated temperatures. The ammonium-containing functional groups may form ionic crosslinks within the polymer structure that resist thermal degradation and maintain polymer integrity under high-temperature conditions. These internal crosslinks may be formed during polymer synthesis or may be introduced through post-polymerization modification processes. The degree of internal crosslinking may be controlled to balance thermal stability with polymer solubility and ease of handling during field operations. In some embodiments, the ammonium-containing crosslinking groups may include quaternary ammonium structures that provide permanent ionic character and enhanced thermal resistance compared to primary or secondary amine groups.

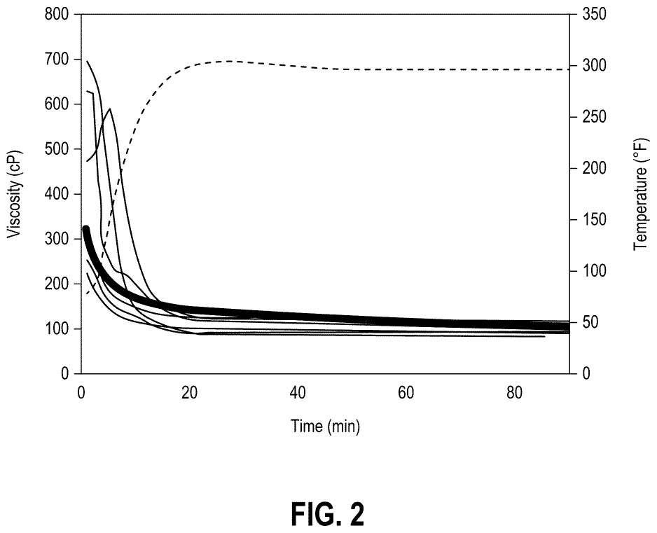

Referring to FIG. 2, the viscosity profile demonstrates the thermal stability of the polymer solution under high-temperature conditions, where the polymer maintains viscosity characteristics over extended exposure periods at temperatures up to 300° F. In FIG. 2, the dotted line represents temperature, while the bold line indicates the viscosity of the aqueous mixture with the polymer and clay stabilizer. The thin lines represent the viscosities of the aqueous mixtures containing the polymer, clay stabilizer, and various foaming surfactants. The concentration of the branched synthetic polymer may range from about 10 ppt to about 200 ppt depending on the desired viscosity characteristics and operational requirements. In some embodiments, the polymer concentration may be between about 40 ppt and about 45 ppt, for example about 42 ppt or about 43 ppt to provide a balance between viscosity building and cost considerations while maintaining adequate thermal stability for high-temperature applications. Higher polymer concentrations may be utilized when greater viscosity or enhanced proppant transport capability may be desired, while lower concentrations may be suitable for applications where reduced polymer loading may be preferred for environmental or economic reasons or combination of a polymer and surfactant or other additive exhibit the synergetic effect resulting in viscosity increase.

The foaming surfactant may include compounds that facilitate foam formation and stability while maintaining compatibility with the polymer system and downhole conditions. The foaming surfactant may include a betaine group that provides amphoteric character and enhanced stability under varying pH conditions encountered during fracturing operations. Betaine-containing surfactants may exhibit reduced sensitivity to water hardness and may maintain foaming performance in the presence of divalent cations such as calcium and magnesium that may be present in formation waters or mixing waters. In some embodiments, the foaming surfactant may include a sulfobetaine group instead of or in addition to a betaine group to provide modified surface activity and foam stability characteristics. Sulfobetaine groups may offer enhanced thermal stability and reduced sensitivity to electrolyte concentration compared to conventional betaine structures.

The foaming surfactant may include various types of surface-active compounds including alkylamido betaines, alkyl polyglycolides, amine oxides, quaternary amines, alkyl ether sulfates, alkylarylsulfonates, ethoxylated long chain alcohols, alkyl sulfates, sulfosuccinates, sodium lauryl sulfoacetate, or sodium lauroyl methyl isethionate. Alkylamido betaines may include compounds such as cocamidopropyl hydroxysultaine, cocamidopropyl betaine, erucic amidopropyl dimethyl betaine, oleoylamidopropyl dimethyl betaine, and erucamidopropyl hydroxypropylsultaine that provide foam formation and stability characteristics suitable for high-temperature applications. In at least one embodiment, the foaming surfactant may be limited to a group consisting of the listed surface-active compounds. In at least one embodiment, the foaming surfactant may include more than those listed. These surfactants may be selected based on their thermal stability, compatibility with the polymer system, and ability to maintain foam structure under downhole pressure and temperature conditions. The concentration of the foaming surfactant may be up to about 60 gpt to provide adequate foam formation while avoiding excessive surfactant loading that may impact fluid economics or environmental considerations. In at least one embodiment, the concentration of surfactant may be upt o about 15 gpt, for example about 12 gpt or about 13 gpt for good performance of the formulation. In some embodiments, surfactant concentrations may be optimized based on specific formation conditions, water chemistry, and operational requirements to achieve desired foam quality and stability characteristics.

The gas phase of the foam fracturing fluid may include carbon dioxide (CO₂) that provides enhanced viscosity characteristics and foam stability under downhole conditions. CO₂ may be introduced as a supercritical fluid under reservoir pressure and temperature conditions, where the supercritical state may provide improved solubility characteristics and enhanced interaction with the liquid phase components. The CO₂ may be sourced from various industrial sources and may be purified to remove impurities that could interfere with foam formation or stability. In some embodiments, the CO₂ may be injected at the surface and mixed with the liquid phase components using specialized mixing equipment that ensures uniform distribution of the gas phase throughout the fluid system. The CO₂ may provide advantages in terms of environmental compatibility and may be recovered from the formation after fracturing operations for reuse or disposal through established carbon management practices.

The gas phase may alternatively or additionally include nitrogen (N₂) that may offer different performance characteristics compared to CO: under specific reservoir conditions. Nitrogen may provide enhanced foam stability in certain applications due to lower solubility in aqueous solutions compared to CO₂, which may reduce foam collapse rates during extended exposure to formation fluids. The nitrogen may be sourced from air separation processes or may be generated on-site using membrane separation or pressure swing adsorption technologies. In some embodiments, nitrogen may be preferred for shallow formations or applications where CO₂ solubility effects may be detrimental to foam performance. The nitrogen may be injected at various pressures and flow rates to achieve desired foam quality characteristics while maintaining compatibility with surface equipment and safety requirements.

Natural gas may serve as an alternative gas phase component that may provide economic advantages in locations where natural gas availability and cost considerations make such applications attractive. The natural gas may include primarily methane along with other hydrocarbon components that may be present in varying concentrations depending on the source and processing history. In some embodiments, the natural gas may be processed to remove hydrogen sulfide, carbon dioxide, or other components that could interfere with foam formation or cause corrosion of equipment. The use of natural gas as a foam phase component may provide compatibility with formation fluids and may reduce environmental concerns associated with the introduction of non-hydrocarbon gases into hydrocarbon-producing formations. The natural gas may be compressed and injected using equipment designed to handle hydrocarbon gases while maintaining appropriate safety protocols for gas handling operations.

Foam quality represents the volumetric percentage of the gas phase under downhole conditions and may be adjusted by varying the gas-to-liquid ratio to achieve desired fluid performance characteristics. The foam quality may range from about 10% to about 75% depending on operational requirements, formation characteristics, and equipment limitations. Lower foam qualities may provide higher liquid phase viscosity and enhanced proppant transport capability, while higher foam qualities may reduce fluid density and improve flowback characteristics in low-pressure formations. In some embodiments, foam quality may be maintained within a range of about 54% to about 74% to balance viscosity requirements with density reduction benefits. Specific foam quality values may include 54%, 55%, 59%, 66%, 72%, and 74%, where each value may correspond to different operational phases or formation requirements encountered during fracturing operations.

The relationship between gas-to-liquid ratios and fluid performance may be characterized through rheological measurements that demonstrate viscosity changes as foam quality varies within the operational range. Higher foam qualities may result in increased apparent viscosity due to the presence of dispersed gas bubbles that contribute to flow resistance and energy dissipation during fluid movement. The gas-to-liquid ratio may be controlled through surface equipment that meters the flow rates of liquid and gas phases prior to mixing and injection into the wellbore. In some embodiments, foam quality may be adjusted during fracturing operations to optimize fluid performance for different stages of the treatment, where initial stages may utilize lower foam qualities for enhanced proppant transport and later stages may employ higher foam qualities for improved cleanup and flowback characteristics. The foam quality may be monitored using density measurements or other techniques that provide real-time feedback on gas-to-liquid ratios during operations.

The liquid phase may further include a clay stabilizer that functions to prevent clay swelling and maintain fluid performance during fracturing operations in formations containing reactive clay minerals. Clay minerals such as montmorillonite, illite, and mixed-layer clays may undergo swelling when exposed to aqueous fracturing fluids, which may result in formation damage, reduced permeability, and impaired hydrocarbon production. The clay stabilizer may interact with clay surfaces through ionic exchange mechanisms or adsorption processes that prevent water uptake and maintain clay structure integrity during fluid contact. The selection of appropriate clay stabilizers may depend on formation mineralogy, water chemistry, and compatibility with other fluid components including the branched synthetic polymer and foaming surfactant.

Choline chloride may serve as a clay stabilizer that provides effective clay swelling prevention while maintaining compatibility with the polymer system. Choline chloride may function through cation exchange mechanisms where the choline cation displaces hydrated cations from clay interlayer spaces, thereby reducing the hydration potential and swelling tendency of clay minerals. The choline cation may form stable associations with clay surfaces due to its quaternary ammonium structure and appropriate molecular size for intercalation between clay layers. In some embodiments, choline chloride may be preferred over other clay stabilizers due to its reduced environmental impact and biodegradability characteristics compared to conventional quaternary ammonium compounds. The choline chloride may be present at concentrations that provide effective clay stabilization without adversely affecting the viscosity characteristics of the polymer solution or interfering with foam formation and stability.

Tetramethylammonium chloride may serve as an alternative clay stabilizer that provides clay swelling inhibition through similar cation exchange mechanisms. The tetramethylammonium cation may exhibit strong affinity for clay surfaces and may provide effective stabilization in formations containing high concentrations of swelling clays. Tetramethylammonium chloride may be utilized in embodiments where enhanced clay stabilization performance may be desired or where specific formation conditions may favor the use of this particular stabilizing compound. The tetramethylammonium cation may form compact arrangements on clay surfaces due to its symmetrical structure, which may result in effective blockage of water access to clay interlayer regions. In some embodiments, tetramethylammonium chloride may be combined with other stabilizing compounds to achieve enhanced performance in complex clay mineral assemblages.

Triethylenetetramine may function as a clay stabilizer through different mechanisms compared to quaternary ammonium compounds, where the multiple amine groups may interact with clay surfaces through hydrogen bonding and electrostatic interactions. The polyamine structure of triethylenetetramine may provide multiple attachment points for interaction with clay surfaces, which may result in enhanced stabilization effectiveness compared to single-site stabilizers. Triethylenetetramine may be particularly effective in formations containing mixed clay mineral assemblages where different stabilization mechanisms may be beneficial for comprehensive clay control. The amine groups within triethylenetetramine may undergo protonation under acidic conditions, which may enhance the electrostatic interaction with negatively charged clay surfaces and improve stabilization performance.

Polyether amines may serve as clay stabilizers that combine the benefits of polyether backbone flexibility with terminal amine functionality for clay surface interaction. The polyether segments may provide enhanced solubility characteristics and reduced sensitivity to water hardness compared to conventional amine-based stabilizers. Polyether amines may exhibit temperature stability characteristics that make them suitable for high-temperature fracturing applications where thermal degradation of stabilizing compounds may be a concern. The molecular weight and structure of polyether amines may be varied to optimize clay stabilization performance for specific formation conditions and clay mineral types. In some embodiments, polyether amines may provide dual functionality as clay stabilizers and foam stability enhancers through their surface-active properties.

Cationic polymers may function as clay stabilizers through polymer adsorption mechanisms that create protective layers on clay surfaces to prevent water access and swelling. The cationic charge density and molecular weight of these polymers may be tailored to provide optimal interaction with clay surfaces while maintaining compatibility with the fracturing fluid system. Cationic polymers may offer advantages in terms of treatment longevity, where the polymer adsorption may provide extended clay stabilization compared to small molecule stabilizers that may desorb over time. The polymer structure may be designed to resist thermal degradation and maintain stabilization effectiveness under high-temperature downhole conditions. In some embodiments, cationic polymers may be selected based on their compatibility with the branched synthetic polymer used for viscosity building to avoid adverse interactions that could affect fluid performance.

Potassium chloride may serve as a clay stabilizer through ionic strength effects and cation exchange mechanisms, where potassium ions may replace hydrated cations in clay interlayer spaces to reduce swelling potential. The potassium cation may exhibit favorable size characteristics for clay interlayer stabilization and may provide cost-effective clay control in many formation types. However, potassium chloride may reduce the viscosity of the polymer solution through ionic interactions that affect polymer conformation and solution behavior. The viscosity reduction effects of potassium chloride may limit the concentration that may be utilized without compromising the rheological performance of the fracturing fluid. In some embodiments, potassium chloride may be less preferred compared to other clay stabilizers due to the potential for adverse effects on polymer performance, particularly in applications where maintaining high viscosity characteristics may be important for proppant transport or fracture geometry control.

The concentration of clay stabilizers may be optimized to provide effective clay swelling prevention while maintaining compatibility with other fluid components and avoiding adverse effects on fluid performance characteristics. Clay stabilizer concentrations may typically range from about 0.1% to about 2% by weight of the liquid phase, depending on formation clay content, clay mineral types, and the specific stabilizer being utilized. Lower concentrations may be sufficient for formations with minimal clay content or less reactive clay types, while higher concentrations may be required for formations containing high concentrations of highly swelling clays such as sodium montmorillonite. The clay stabilizer concentration may be determined through laboratory testing that evaluates clay swelling inhibition effectiveness while monitoring effects on polymer viscosity, foam formation, and other fluid performance parameters. In some embodiments, combinations of different clay stabilizers may be utilized to achieve enhanced performance or to address complex clay mineral assemblages that may require multiple stabilization mechanisms.

The thermal stability characteristics of the foam fracturing fluid may be demonstrated through viscosity measurements conducted at elevated temperatures over extended time periods. The fluid may maintain viscosity characteristics that support fracturing operations in high-temperature reservoir environments where conventional fluids may experience thermal degradation. The branched synthetic polymer component may contribute to thermal resistance through polymer backbone stability and crosslinking mechanisms that resist thermal breakdown at temperatures encountered in deep formations. The foaming surfactant may exhibit thermal stability characteristics that maintain foam formation and stability under high-temperature conditions where conventional surfactants may undergo degradation or desorption from gas-liquid interfaces.

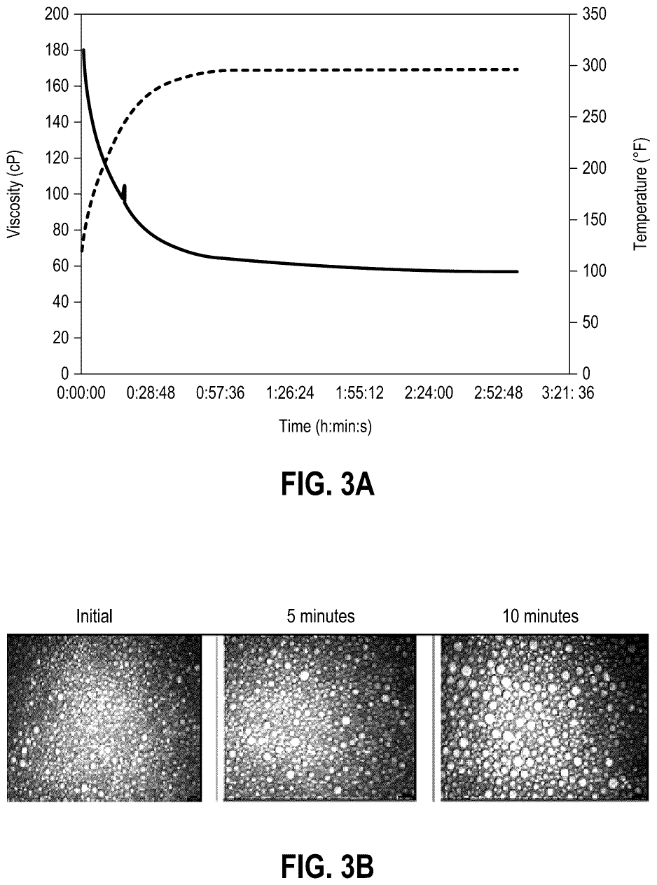

FIG. 3A shows the viscosity profile of a two-phase fluid, where the liquid phase is an aqueous solution of a branched polymer and betaine-based foaming surfactant. The graph of FIG. 3A displays two lines—a solid line representing viscosity measurements and a dashed line representing temperature. The viscosity measurements were conducted at a constant shear rate of 100 s⁻¹ over a period of approximately 3 hours and 20 minutes, with temperature increasing rapidly during the initial phase and stabilizing at approximately 300° F. The foam quality for this test was maintained at 54%, representing the volumetric percentage of gas phase under the test conditions.

The viscosity profile in FIG. 3A demonstrates an initial value of approximately 180 cp that decreases during the temperature ramp-up period before stabilizing at around 60 cp for the remainder of the test duration. This stabilization of viscosity under elevated temperature conditions indicates the thermal resistance of the foam fluid system, which maintains sufficient viscosity for effective proppant transport and fracture creation even after prolonged exposure to high temperature. The data demonstrate that the foam fluid remains stable under high temperature and pressure conditions up to 1550 psig, making it suitable for use as a hydraulic fracturing fluid in high-temperature reservoirs.

FIG. 3B shows the bubble structure evolution of the foam fluid after exposure to high temperatures for at least 2 hours. The images were captured at initial conditions, after 5 minutes, and after 10 minutes to document the foam stability characteristics over time. The consistent bubble structure observed throughout the observation period further confirms the exceptional stability of the foam system under thermal stress.

The data in FIGS. 3A and 3B were obtained using an HPHT (High Pressure High Temperature) closed-loop foam rheometer equipped with a digital camera for visual observation of foam structure. This specialized equipment enables simultaneous measurement of rheological properties and visual documentation of foam characteristics under controlled temperature and pressure conditions that simulate downhole environments. The foam's half-life, determined through these observations, exceeded industry standards for high-temperature applications, further demonstrating the enhanced stability provided by the combination of branched synthetic polymer and betaine-based foaming surfactant in the presence of CO₂ as the gas phase.

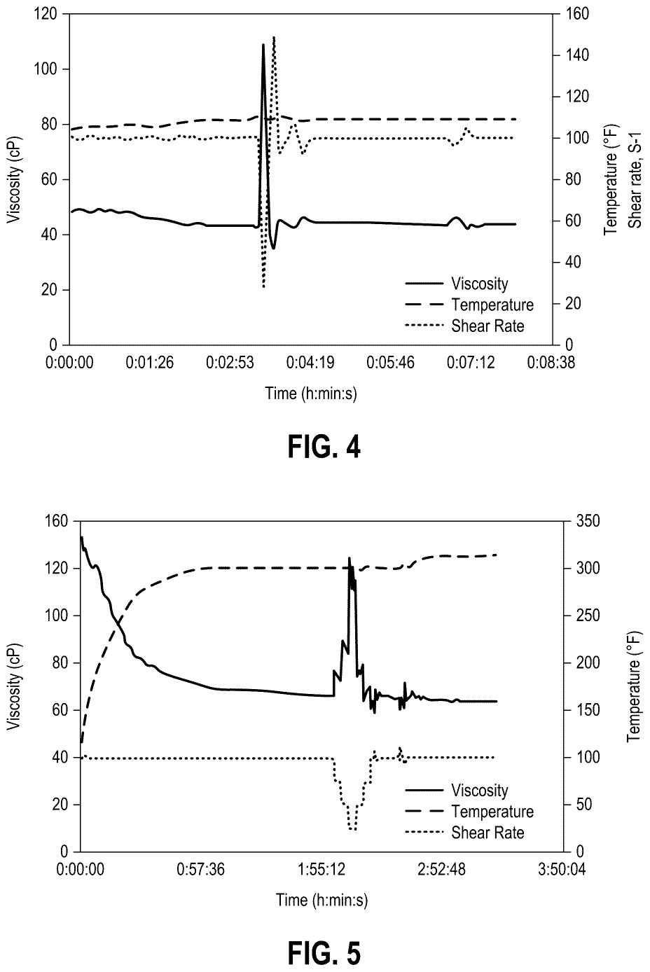

FIG. 4 demonstrates the viscosity profile of a base fluid obtained with a closed-loop foam rheometer at a targeted 100s⁻¹ shear rate over an extended measurement period. The base fluid formulation contains 35 lbs/1000 gallons of branched polymer and 10 gallons of betaine-based foaming surfactant per 1000 gallons of base fluid, representing a typical composition used in high-temperature fracturing applications. The graph displays three key parameters tracked simultaneously during the rheological evaluation: viscosity (represented by the bold line), temperature (represented by the dashed line), and shear rate (represented by the dotted line), providing comprehensive characterization of the fluid's behavior under controlled conditions.

The viscosity measurements reveal remarkable stability throughout the test duration, with the fluid maintaining consistent rheological properties despite the applied shear forces. This stability is particularly noteworthy as it demonstrates the robust nature of the branched polymer structure. The temperature profile remains relatively constant at approximately 109° F. during the measurement period, providing a baseline characterization of the fluid's performance under ambient temperature conditions before exposure to elevated temperatures that would be encountered in downhole environments. The shear rate measurements confirm the maintenance of the targeted 100 s⁻¹ value throughout the test, ensuring that the viscosity data accurately represents the fluid's behavior under the specified flow conditions.

The data obtained offers valuable insights into the base fluid's behavior before gas phase introduction, establishing a reference point for subsequent foam quality evaluations. When compared with the foam fluid performance shown in FIG. 5, these results demonstrate that the base fluid possesses inherent stability that contributes to the overall performance of the foam system, while the introduction of CO₂ significantly enhances the viscosity profile through the formation of a stable two-phase structure with improved rheological properties. The results shown in FIG. 4 may be obtained at temperatures around 109-deg. F, while FIG. 5 discussed below includes higher temperatures, for example about 300-deg. F.

FIG. 5 shows the viscosity profile of a CO2 foam fluid having 74% foam quality at temperature up to 313° F. The base fluid contains 35 lbs/1000 gallons of branched polymer and 10 gallons of betaine based foamer per 1000 gallons of base fluid. First, the CO2 foam fluid was exposed to 100 s−1 shear rate and heated to 300° F. After viscosity stabilization the fluid was exposed to shear ramp than heated up to 313° F. The bold line represents viscosity, while dashed and dotted line represent temperature and shear rate, respectively. The viscosity measurements demonstrate remarkable stability throughout the initial heating phase, with the foam fluid maintaining consistent rheological properties despite the rapid temperature increase to 300° F.

The graph reveals several notable features of the foam fluid's behavior under elevated temperature and shear conditions. Following the initial stabilization period, the viscosity profile shows a response to the applied shear ramp, demonstrating the fluid's shear-thinning characteristics that are beneficial for field applications. When the temperature was further increased to 313° F., the foam fluid continued to maintain substantial viscosity, indicating exceptional thermal stability at temperatures exceeding typical reservoir conditions. This sustained performance at extreme temperatures highlights the effectiveness of the branched polymer and betaine-based foamer combination in creating a robust foam structure that resists thermal degradation. The periodic fluctuations in the viscosity measurements correspond directly to changes in the applied shear rate, confirming the fluid's responsive rheological behavior under varying flow conditions.

The data on FIG. 4 and FIG. 5 demonstrate that mixing CO2 with base fluid forms stable fluid and that CO2 significantly enhances the viscosity of the base fluid. This enhancement is particularly evident when comparing the viscosity values between the base fluid alone (shown in FIG. 4) and the CO2 foam fluid (shown in FIG. 5), where the foam system exhibits substantially higher viscosity under comparable temperature and shear conditions. The 74% foam quality provides an optimal balance between viscosity enhancement and density reduction, creating a fluid system with superior proppant transport capabilities while maintaining the pressure transmission characteristics needed for effective fracture creation. The sustained performance of the foam fluid throughout the extended test period confirms its suitability for high-temperature fracturing applications where conventional fluids might experience rapid degradation and loss of functionality.

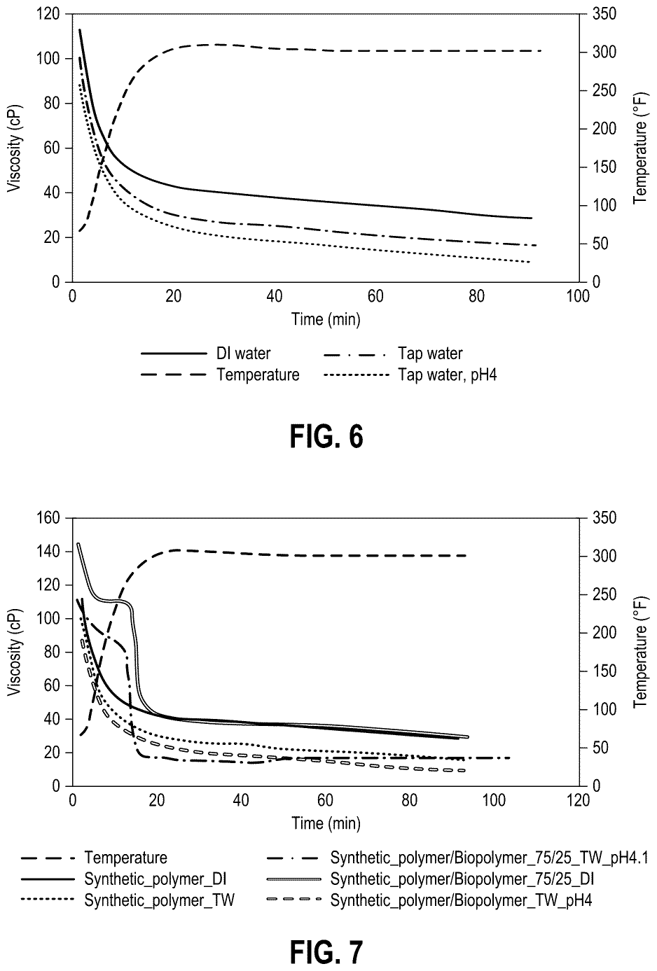

Referring to FIG. 6, the viscosity profiles demonstrate the performance of the synthetic polymer solution under various water chemistry conditions and temperature exposure scenarios. The viscosity measurements may be conducted using deionized water, tap water, and tap water adjusted to pH 4 to simulate the acidic conditions that may result from CO: dissolution in the aqueous phase. The polymer solution prepared with deionized water may exhibit higher viscosity values compared to solutions prepared with tap water due to the absence of dissolved minerals that may interact with polymer chains and affect solution rheology. The presence of dissolved minerals in tap water may result in polymer chain interactions that reduce the effective hydrodynamic volume of the polymer molecules and decrease solution viscosity. The pH adjustment to acidic conditions may further reduce viscosity through protonation effects on polymer functional groups, which may alter polymer conformation and intermolecular interactions within the solution.

As shown in FIG. 6, the polymer in DI water can be maintained at about 29 cp after exposure to temperatures of 200° F. to 300° F. for at least 90 minutes, demonstrating thermal stability characteristics suitable for high-temperature fracturing applications. Further, in some experiments, the disclosed polymer solution in tap water with a pH adjusted to 4 is about 38 cp at 200° F. at 83 minutes into the experiment, and 10cp at 300° F. The viscosity retention over extended exposure periods may indicate that the polymer structure remains intact and functional under thermal stress conditions that may cause degradation of conventional polymer systems. The 90-minute exposure period may represent typical treatment durations encountered during fracturing operations, where the fluid may be subjected to elevated temperatures during pumping, placement, and residence time within the formation. The temperature range of 200° F. to 300° F. may encompass the thermal conditions encountered in many deep reservoir applications where enhanced oil recovery techniques may be employed to access hydrocarbon resources.

With continued reference to FIG. 6, the viscosity profiles may show gradual decreases over time as the polymer solution reaches thermal equilibrium at elevated temperatures. The initial viscosity values may be higher due to incomplete thermal equilibration, while the stabilized viscosity values may represent the steady-state performance characteristics under sustained high-temperature exposure. In addition, in the experiment shown in FIG. 6, the sample was heated for the first 25 minutes such that the viscosity is higher initially not only because of incomplete thermal equilibrium, but also because initial temperature is low. The polymer solution prepared with deionized water may maintain viscosity values above 29 cp at 90 min into the experiment, while solutions prepared with tap water may have viscosity values 19 cp at 90 min into the experiment. The acidified solution may exhibit lower viscosity values but may still maintain adequate rheological properties for fracturing applications where moderate viscosity levels may be sufficient for fluid placement.

The composition may be formulated to maintain thermal stability at temperatures up to 300° F. through careful selection of polymer monomers and crosslinking mechanisms that resist thermal degradation. The thermal stability may be achieved through polymer backbone structures that exhibit high bond dissociation energies and resist chain scission reactions at elevated temperatures. The internal crosslinking with ammonium-containing functional groups may provide additional thermal resistance by creating ionic associations that stabilize polymer structure against thermal stress. The foaming surfactant selection may consider thermal stability characteristics to ensure that foam formation and stability may be maintained throughout the temperature range encountered during fracturing operations. The combination of thermally stable polymer and surfactant components may result in a fluid system that maintains performance characteristics under conditions where conventional fracturing fluids may experience degradation or loss of functionality. The combination of a polymer and surfactant may exhibit synergetic effect resulting in viscosity increase.

The foam fracturing fluid may exhibit shear-thinning behavior where viscosity decreases with increasing shear rate and recovers afterward, providing operational advantages during pumping and placement operations. The shear-thinning characteristics may result from polymer chain alignment and disentanglement under applied shear stress, which may reduce flow resistance and facilitate fluid movement through surface equipment and wellbore tubulars. The viscosity recovery after shear removal may occur through polymer chain relaxation and re-entanglement processes that restore the original fluid structure and rheological properties. This behavior may be beneficial for fracturing operations where reduced viscosity during pumping may decrease pressure requirements and energy consumption, while viscosity recovery after placement may enhance proppant transport and suspension characteristics within the created fractures.

The shear-thinning behavior may be characterized through rheological measurements that evaluate viscosity changes across a range of shear rates representative of conditions encountered during fracturing operations. Low shear rate conditions may correspond to fluid residence within fractures or storage tanks, while high shear rate conditions may represent flow through pumps, surface lines, and wellbore restrictions. The degree of shear-thinning may be quantified through flow behavior index values that describe the relationship between shear stress and shear rate for the fluid system. The viscosity recovery characteristics may be evaluated through time-dependent measurements that monitor viscosity restoration after cessation of applied shear stress. The recovery kinetics may depend on polymer molecular weight, concentration, and crosslinking density, where higher molecular weight polymers may exhibit slower recovery rates due to longer relaxation times for chain re-entanglement processes.

The thermal performance characteristics may be influenced by the concentration of polymer and surfactant components, where higher concentrations may provide enhanced thermal stability through increased intermolecular interactions and cooperative stabilization effects. The polymer concentration may be optimized to balance thermal stability requirements with economic considerations and environmental impact factors. Lower polymer concentrations may be sufficient for moderate temperature applications, while higher concentrations may be utilized for extreme temperature conditions where enhanced thermal resistance may be desired. The surfactant concentration may affect foam stability under thermal stress, where adequate surfactant levels may maintain gas-liquid interface stability while excessive concentrations may result in surfactant precipitation or phase separation at elevated temperatures. The interaction between polymer and surfactant components may contribute to overall thermal stability through synergistic effects that enhance the performance of individual components within the fluid system.

The liquid phase may include a combination of the branched synthetic polymer with a biopolymer at specific weight ratios to achieve enhanced performance characteristics under high-temperature conditions. The biopolymer component may include naturally occurring polymers such as xanthan gum, guar gum, or other polysaccharide-based materials that provide complementary rheological properties when combined with the synthetic polymer system. The combination of synthetic and biopolymer components may result in synergistic effects where the overall fluid performance exceeds that of individual polymer components used separately. The biopolymer may contribute to viscosity building through different mechanisms compared to the synthetic polymer, where the natural polymer chains may provide additional entanglement networks and hydrogen bonding interactions that enhance fluid structure and thermal stability.

The weight ratio of synthetic polymer to biopolymer may be optimized to balance performance characteristics with cost considerations and environmental impact factors. In some embodiments, the combination may include 75% synthetic polymer and 25% biopolymer by weight of the total polymer content, where this ratio may provide enhanced viscosity characteristics while maintaining thermal stability under high-temperature exposure conditions. The 75:25 ratio may represent an optimal balance where the synthetic polymer provides the primary thermal resistance and structural integrity, while the biopolymer contributes to viscosity enhancement and fluid stability through complementary molecular interactions. Alternative weight ratios may be utilized depending on specific formation conditions, temperature requirements, and operational objectives, where ratios ranging from 90:10 to 50:50 synthetic to biopolymer may be employed to achieve desired fluid properties.

Referring to FIG. 7, the performance characteristics of polymer blend formulations may be compared to single-polymer systems under various water chemistry and temperature conditions. The viscosity profiles demonstrate that the synthetic polymer-biopolymer blend may exhibit enhanced performance compared to the synthetic polymer alone under certain conditions. The blend formulation may show improved viscosity retention over time and enhanced stability under thermal stress conditions that may cause degradation of individual polymer components. The biopolymer component may contribute to viscosity building through chain entanglement mechanisms that complement the crosslinking effects of the synthetic polymer, resulting in enhanced fluid structure and rheological properties.

The comparative performance data may indicate that the polymer blend maintains higher viscosity values compared to equivalent concentrations of synthetic polymer alone, particularly under conditions where water chemistry effects may reduce the effectiveness of individual polymer components. The biopolymer may provide buffering effects against ionic interactions that could otherwise reduce synthetic polymer performance in high-salinity environments or in the presence of divalent cations. The blend formulation may exhibit reduced sensitivity to pH variations that may occur due to CO₂ dissolution or acid treatments, where the biopolymer component may maintain functionality under acidic conditions that could affect synthetic polymer performance. The synergistic effects between synthetic and biopolymer components may result in enhanced thermal stability, where the combination resists thermal degradation more effectively than individual polymer systems under equivalent exposure conditions.

The viscosity measurements in FIG. 7 may demonstrate that the polymer blend formulation maintains stable rheological properties over extended exposure periods at elevated temperatures. The blend system may exhibit gradual viscosity changes that stabilize at levels suitable for fracturing applications, where the combined polymer system provides adequate fluid properties for proppant transport and fracture geometry control. The biopolymer component may contribute to shear-thinning behavior that enhances pumping characteristics while maintaining viscosity recovery properties that support proppant suspension within created fractures. The molecular weight distribution and structural characteristics of the biopolymer may be selected to complement the synthetic polymer properties and achieve desired flow behavior under various shear rate conditions encountered during fracturing operations.

The polymer blend formulations may offer advantages in terms of environmental compatibility and biodegradability compared to synthetic polymer systems alone. The biopolymer component may undergo natural degradation processes that reduce the environmental persistence of the fracturing fluid system after treatment completion. The combination of synthetic and natural polymer components may provide a balance between performance requirements and environmental considerations, where the synthetic component provides thermal stability and the biopolymer contributes to biodegradability and reduced environmental impact. The blend formulations may be particularly suitable for applications where environmental regulations or operator preferences favor the use of partially biodegradable fluid systems while maintaining performance characteristics suitable for high-temperature fracturing operations.

TABLE 1

| | | Foam | |
|---|---|---|---|
| Polymer | Foamer Type | Quality, % | Viscosity |
| Synthetic | Alkylamido | 0 | 3 |
| polymer, | betaine I, | 55.6 | 26 |
| 20 ppt | 10 gpt | 66 | 34 |
| | | 77.9 | 78.6 |
| Synthetic | Alkylamido | 0 | 9.7 |
| polymer, | betaine I, | 55 | 29 |
| 35 ppt | 10 gpt | 59 | 31 |
| | | 66 | 40 |
| | | 72 | 69 |
| | | 74 | 75 |
| Synthetic | Alkylamido | 59 | 57 |
| polymer, | betaine I, | | |
| 100 ppt | 10 gpt | | |
| Synthetic | Alkylamido | 0 | 18.7 |
| polymer, | betaine II, | 50.6 | 34.5 |
| 35 ppt | 10 gpt | 68 | 72 |
| | | 71 | 74 |
| Synthetic | Amphoteric based | 0 | 27 |
| polymer, | viscoelastic | 64 | 53 |
| 35 ppt | surfactant I, | 68 | 63 |
| | 10 gpt | 73 | 65 |
| Synthetic | Amphoteric based | 0 | 23 |
| polymer, | viscoelastic | 69 | 78 |
| 35 ppt | surfactant II, | 78 | 92 |
| | 10 gpt | | |
| Synthetic | Amphoteric based | 70 | 100 |
| polymer, | viscoelastic | | |
| 42.7 ppt | surfactant II, | | |
| | 12.2 gpt | | |
| Synthetic | Alkylamido | 0 | 17 |
| polymer, | betaine I, | 60 | 30 |
| 26.25 ppt + | 10 gpt | 67 | 37 |
| Biopolymer, | | 76.1 | 75.2 |
| 8.75 ppt | | | |

Table 1 above shows the viscosity of an example foam containing a synthetic polymer at different concentrations or mixture of synthetic polymer and biopolymer, and different surfactants. The polymers, foam types, foam quality values, and viscosity values listed in Table 1 are given by way of non-limiting examples only.

The liquid phase may include breaker systems that facilitate controlled degradation of the foam fracturing fluid after completion of fracturing operations. Breaker systems may function to reduce fluid viscosity and promote flowback of treatment fluids from the formation, thereby minimizing formation damage and enhancing hydrocarbon production. The breaker components may be designed to activate under specific downhole conditions such as elevated temperature, pH changes, or contact with formation fluids that trigger degradation mechanisms. The selection of appropriate breaker systems may depend on formation characteristics, treatment duration requirements, and the desired timing for fluid breakdown relative to fracturing operations and production initiation.

Unencapsulated breakers may be incorporated directly into the liquid phase to provide immediate or time-delayed fluid degradation based on chemical reaction kinetics and downhole conditions. These breaker compounds may begin degradation processes upon contact with formation fluids or may activate when exposed to elevated temperatures encountered during fluid placement and residence within the formation. Unencapsulated breakers may offer advantages in terms of cost and simplicity of fluid preparation, where the breaker compounds may be mixed directly with other fluid components without requiring specialized encapsulation processes or materials. The activation timing of unencapsulated breakers may be controlled through selection of breaker compounds with appropriate reaction kinetics for the anticipated downhole conditions and treatment duration requirements.

Encapsulated breakers may provide controlled release mechanisms that delay breaker activation until specific conditions are encountered within the formation. The encapsulation materials may include polymeric coatings, wax matrices, or other barrier materials that protect the breaker compounds from premature activation during fluid preparation, pumping, and initial placement operations. The encapsulation systems may be designed to degrade or dissolve under specific temperature, pH, or chemical conditions that correspond to desired timing for fluid breakdown. Encapsulated breakers may offer enhanced control over fluid degradation timing compared to unencapsulated systems, where the encapsulation materials may provide predictable release profiles based on downhole exposure conditions and residence time requirements.

The breaker compounds may include various chemical species that function through different degradation mechanisms to reduce polymer viscosity and promote fluid breakdown. Diammonium peroxidisulphate may serve as an oxidizing breaker that cleaves polymer chains through free radical mechanisms initiated by thermal decomposition of the peroxidisulphate compound. The oxidative degradation process may result in polymer chain scission and molecular weight reduction that decreases solution viscosity and facilitates fluid removal from the formation. Diammonium peroxidisulphate may exhibit temperature-dependent activation characteristics where higher temperatures accelerate decomposition rates and enhance breaker effectiveness under high-temperature downhole conditions.

Erythorbic acid may function as a reducing breaker that interacts with polymer crosslinking mechanisms or functional groups to disrupt polymer structure and reduce viscosity characteristics. The reducing properties of erythorbic acid may complement oxidizing breaker systems in formulations where multiple degradation pathways may enhance overall breaker effectiveness. Erythorbic acid may exhibit pH-dependent activity where acidic conditions may enhance breaker performance through protonation effects that modify polymer structure and susceptibility to degradation. The compound may provide environmentally compatible breaker functionality due to its biodegradable characteristics and reduced toxicity compared to some conventional breaker systems.

Triethanolamine may serve as an alkaline breaker that functions through pH modification mechanisms that affect polymer stability and crosslinking interactions. The amine functionality of triethanolamine may interact with acidic functional groups within the polymer structure to disrupt ionic crosslinks and reduce polymer effectiveness. Triethanolamine may also function as a chelating agent that sequesters metal ions involved in polymer crosslinking mechanisms, thereby reducing crosslink density and promoting fluid degradation. The compound may exhibit temperature-dependent activity where elevated temperatures enhance the rate of polymer-breaker interactions and accelerate fluid breakdown processes.

Sodium bromate may function as an oxidizing breaker that generates reactive bromine species under downhole conditions to promote polymer chain degradation through halogenation and oxidation reactions. The bromate compound may exhibit pH-dependent activation where acidic conditions promote decomposition and generation of reactive bromine species that interact with polymer functional groups. Sodium bromate may provide delayed activation characteristics where the compound remains stable during fluid preparation and pumping operations but activates under specific downhole conditions that promote decomposition reactions. The oxidative degradation mechanisms may result in polymer chain scission and crosslink disruption that reduces fluid viscosity and enhances flowback characteristics.

Enzymatic breakers such as 1,4-alpha-d-glucan gulcanohydrolase may provide selective degradation of biopolymer components within polymer blend formulations through specific enzymatic cleavage of glycosidic bonds. The enzyme may exhibit substrate specificity for polysaccharide structures commonly found in biopolymer components such as guar gum or xanthan gum, while having minimal effect on synthetic polymer components. Enzymatic breakers may function under mild conditions that preserve formation integrity while providing effective degradation of target polymer components. The enzyme activity may be influenced by temperature, pH, and ionic strength conditions within the formation, where optimal conditions may enhance enzymatic degradation rates and breaker effectiveness.

Ethylene glycol may serve as a breaker component that functions through solvent effects and polymer swelling mechanisms that disrupt polymer structure and reduce viscosity characteristics. The glycol compound may interact with polymer chains through hydrogen bonding mechanisms that modify polymer conformation and intermolecular interactions within the fluid system. Ethylene glycol may also function as a freezing point depressant that maintains fluid mobility under low-temperature conditions that could otherwise result in fluid gelation or precipitation. The compound may provide compatibility with various polymer systems while offering environmentally acceptable characteristics for oilfield applications.

Sodium bisulfite may function as a reducing breaker that interacts with oxidized polymer functional groups or crosslinking mechanisms to promote polymer degradation and viscosity reduction. The sulfite compound may generate sulfur dioxide under acidic conditions that may contribute to polymer degradation through chemical modification of polymer functional groups. Sodium bisulfite may exhibit synergistic effects when combined with other breaker compounds, where the reducing properties may complement oxidizing breakers to provide enhanced overall degradation effectiveness. The compound may provide cost-effective breaker functionality while maintaining compatibility with various fluid components and formation conditions.

Ammonium persulfate may serve as a thermal breaker that decomposes under elevated temperature conditions to generate sulfate radicals that promote polymer chain scission and crosslink disruption. The persulfate compound may exhibit temperature-dependent activation kinetics where higher temperatures accelerate decomposition rates and enhance breaker effectiveness. Ammonium persulfate may provide predictable activation timing based on formation temperature conditions, where the thermal decomposition characteristics may be utilized to control fluid breakdown timing relative to fracturing operations and production initiation. The compound may offer advantages in high-temperature applications where thermal activation provides reliable breaker performance under extreme downhole conditions.

The concentration and selection of breaker compounds may be optimized based on polymer type, formation conditions, and desired fluid breakdown timing to achieve effective viscosity reduction while maintaining adequate fluid performance during fracturing operations. Lower breaker concentrations may provide extended fluid stability with gradual degradation over time, while higher concentrations may result in rapid fluid breakdown for applications where quick cleanup may be desired. The breaker selection may consider compatibility with other fluid components including clay stabilizers, surfactants, and corrosion inhibitors to avoid adverse interactions that could affect breaker performance or fluid stability. The optimization process may involve laboratory testing under simulated downhole conditions to evaluate breaker effectiveness, activation timing, and compatibility with specific fluid formulations and formation characteristics.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A two-phase liquid-gas fluid for hydraulic fracturing, comprising:
a liquid phase comprising a foaming surfactant and a branched synthetic polymer, wherein the branched synthetic polymer comprises monomers including at least one of acrylamide, acrylic acid, methacrylic acid, or 2-acrylamido-2-methylpropane sulfonic acid; and
a gas phase comprising CO2, wherein the two-phase liquid-gas fluid is configured to maintain a viscosity of at least 70 cp after exposure to temperatures of 200° F. to 300° F. for at least 90 minutes.

2. The two-phase liquid-gas fluid of claim 1, wherein the branched synthetic polymer is internally crosslinked with functional groups including ammonium.

3. The two-phase liquid-gas fluid of claim 1, wherein a concentration of the branched synthetic polymer is from about 10 ppt to about 200 ppt.

4. The two-phase liquid-gas fluid of claim 3, wherein the concentration of the branched synthetic polymer is between about 40 ppt and about 45 ppt.

5. The two-phase liquid-gas fluid of claim 1, wherein a concentration of the foaming surfactant is up to about 60 gpt.

6. The two-phase liquid-gas fluid of claim 1, wherein the foaming surfactant comprises a betaine group.

7. The two-phase liquid-gas fluid of claim 6, wherein the foaming surfactant comprises at least one of:
an alkylamido betaine;
an alkylamido sultaine;
an alkyl polyglycolide;
an amine oxide;
a quaternary amine;
an alkyl ether sulfate;
an alkylarylsulfonate;
an ethoxylated long chain alcohol;
an alkyl sulfate;
a sulfosuccinate;
a sodium lauryl sulfoacetate; or
a sodium lauroyl methyl isethionate.

8. The two-phase liquid-gas fluid of claim 1, wherein the liquid phase further comprises a clay stabilizer.

9. The two-phase liquid-gas fluid of claim 8, wherein the clay stabilizer comprises at least one of choline chloride, tetramethylammonium chloride, triethylenetetramine, a polyether amine, or a cationic polymer.

10. The two-phase liquid-gas fluid of claim 1, wherein a foam quality of the two-phase liquid-gas fluid is from about 10% to about 75%.

11. The two-phase liquid-gas fluid of claim 10, wherein the foam quality is from about 54% to about 74%.

12. A method for hydraulic fracturing of a subsurface formation, comprising:
preparing a foam fluid comprising a liquid phase and a gas phase, wherein:
the liquid phase comprises a foaming surfactant and a branched synthetic polymer comprising monomers including at least one of of acrylamide, acrylic acid, methacrylic acid, or 2-acrylamido-2-methylpropane sulfonic acid; and
the gas phase comprises CO2; and
injecting the foam fluid into the subsurface formation at a pressure higher than formation pressure to create fractures in the subsurface formation.

13. The method of claim 12, wherein the branched synthetic polymer is internally crosslinked with functional groups including ammonium.

14. The method of claim 12, wherein the liquid phase further comprises a clay stabilizer.

15. The method of claim 14, wherein the clay stabilizer comprises choline chloride.

16. The method of claim 12, wherein a foam quality of the foam fluid is from about 54% to about 74%.

17. A composition for high-temperature hydraulic fracturing, comprising:
a branched synthetic polymer comprising monomers including at least one of acrylamide, acrylic acid, methacrylic acid, or 2-acrylamido-2-methylpropane sulfonic acid, wherein the branched synthetic polymer is internally crosslinked with functional groups including ammonium; and
a foaming surfactant comprising a betaine group, wherein the composition is formulated to maintain thermal stability at temperatures up to 300° F.

18. The composition of claim 17, wherein the foaming surfactant comprises one or more alkylamido betaines including at least one of cocamidopropyl hydroxysultaine, cocamidopropyl betaine, erucic amidopropyl dimethyl betaine, erucamidopropyl hydroxypropylsultaine, oleoylamidopropyl dimethyl betaine, or erucamidopropyl hydroxypropylsultaine.

19. The composition of claim 17, further comprising a clay stabilizer.

20. The composition of claim 19, wherein the clay stabilizer comprises choline chloride.
